(19) United States
(12) Patent Application Publication
(10) Pub. No.: US 2006/0129562 A1
(43) Pub. Date: Jun. 15, 2006

(54) System and method for management of recovery point objectives of business continuity/disaster recovery IT solutions

(76) Inventors: Chandrasekhar Pulamarasetti, Bangalore (IN); Rajasekhar Mulpuri, Bangalore (IN); Lakshman Narayanaswamy, Bangalore (IN); Ravi Kumar Raghunathan, Bangalora (IN); Krishna Nimishakavi, Bangalore (IN); Rajasekhar Vonna, Bangalore (IN)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/240,768

(22) Filed: Oct. 3, 2005

Related U.S. Application Data
(60) Provisional application No. 60/615,641, filed on Oct. 4, 2004.

(51) Int. Cl. G06F 17/30

(52) U.S. Cl. 707/10

(57) ABSTRACT

The present invention provides a system and method for management of Recovery Point Objectives (RPO) of a business continuity or disaster recovery solution. The system comprises a management server logically coupled with at least a first computer, at least a second computer, and a network coupling the first and the second computers. The first and second computers host at least one continuously available application and at least one data protection scheme for replicating the application data; the application data being periodically replicated from the first computer to at least the second computer. The system manages RPO by inputting an RPO value for the solution, calculating a real time RPO value for the solution, and making the real time RPO value equal to the input RPO value.

### FIELD OF INVENTION

The present invention relates generally to computer systems. More particularly, the present invention relates to monitoring, measurement and management of Recovery Point Objectives (RPO) of enterprise IT business continuity or disaster recovery solutions.

### BACKGROUND OF THE INVENTION

In the increasingly competitive times of today, implementing systems and methods for maintaining business continuity is no longer an optional requirement for business enterprises, especially for enterprises that use or are fully or partially dependent on Information Technology (IT). Such enterprises can be broadly termed as IT enterprises. Since the efficient working of most of such IT enterprises depends on their business continuity or disaster recovery management infrastructure, implementing a sound enterprise IT business continuity or disaster recovery solution has almost become a mandatory requirement. Costs incurred during business downtime are usually significant, thereby dictating a need for implementing a business continuity solution. The design and choice of the business continuity or disaster recovery solution is primarily driven by a Recovery Point Objective (RPO) that is acceptable to the IT enterprise.

RPO for an IT enterprise business continuity or disaster recovery solution is a time measure that defines the amount of data loss that is acceptable to the IT enterprise when a production or application site becomes unavailable due to an outage. In other words, when a disaster or an outage renders an IT business continuity solution unavailable, RPO is the data loss in time units that the IT enterprise can accept without adverse impact. For example, if in an IT enterprise, backup of data is taken everyday at 11 p.m. and an outage occurs at 2 p.m. on a particular day, the IT enterprise will have to fall back to the backup taken at 11 p.m. on the previous day. Therefore, once a day backup results in an RPO value of 24 hours.

Enterprise data may be generally classified into four categories. (1) Critical “Tier One” data, where loss of data has an immediate impact on the enterprise's revenue or functioning; (2) Vital “Tier Two” data, where loss of data has a significant impact on the enterprise's revenue or functioning; (3) Essential “Tier Three” data, where loss of data has some impact on the enterprise's revenue or functioning; and (4) Non-Essential “Tier Four” data, where loss of data has minimal impact on the enterprise's revenue or functioning. Therefore, the challenge faced by most enterprises lies in identifying the criticality of their IT enterprise application data and impact of loss of the same. One way to achieve this goal is to recognize an acceptable amount of data loss associated with each type of data. Hence, an RPO measure is used to characterize data loss for a business continuity or disaster recovery solution.

A conventional business continuity or disaster recovery solution has three main components namely: an enterprise application that requires being available continuously, a data protection scheme that makes a copy of the application data, and the entire supporting infrastructure which comprises computer servers, storage arrays and local and remote networks. Conventional business continuity or disaster recovery solutions based on an RPO measure may not integrate with all the three components. Some of the currently available business continuity or disaster recovery solutions work with a static value of RPO and do not provide for a real time measurement of RPO based on real time inputs obtained from all the three components. Hence, there is need for a business continuity or disaster recovery solution that is based on real time measurement and management of RPO by using real time inputs from the mentioned components.

Some of the available methods to manage RPO in a business continuity or disaster recovery solution are manual, and usually entail an operator monitoring the proper functioning of each of the three components and taking appropriate corrective actions, if required. The constant manual monitoring and performing of corrective actions maintains business continuity of the enterprise application that requires being available continuously. Such corrective actions have to be customized for every type of enterprise application, data protection scheme and supporting infrastructure components used for the business continuity or disaster recovery solution. Therefore, these actions require that the operator possesses an in-depth technical knowledge of all the components in the business continuity or disaster recovery solution. Such dependence on manual intervention may lead to erroneous operation of the solution and added costs for the business enterprise that implements the solution.

Therefore, there is need for an automated business continuity or disaster recovery solution in which RPO is continuously managed to a user desired or configured value.

### SUMMARY OF THE INVENTION

The present invention provides automated systems and methods for monitoring, measurement and management of Recovery Point Objectives (RPO) of enterprise IT business continuity or disaster recovery solutions.

It is an objective of the present invention to provide systems and methods that monitor the RPO of enterprise IT business continuity or disaster recovery solutions, in real time.

It is another objective of the present invention to provide systems and methods that manage the enterprise IT business continuity or disaster recovery solutions such that the desired RPO value is achieved.

It is yet another objective of the present invention to provide systems and methods for monitoring and managing the RPO of enterprise IT business continuity or disaster recovery solutions that integrate with the various components of the business continuity or disaster recovery solution.

It is still another objective of the present invention to provide systems and methods for managing the RPO of enterprise IT business continuity or disaster recovery solutions that enable a user to input or configure a desired RPO value for the business continuity or disaster recovery solution.

It is still another objective of the present invention to provide systems and methods for managing the RPO of enterprise IT business continuity or disaster recovery solutions that raise alerts and alarms when the RPO deviates from its desired or configured value.

It is yet another objective of the present invention to provide systems and methods for managing the RPO of enterprise IT business continuity or disaster recovery solutions that take corrective actions to maintain the RPO at its desired or configured value.

It is still another objective of the present invention to provide systems and methods for managing the RPO of enterprise IT business continuity or disaster recovery solutions that specify policies which further decide actions to be performed when the RPO value deviates from its desired or configured value.

It is another objective of the present invention to provide systems and methods for managing the RPO of enterprise IT business continuity or disaster recovery solutions that may be executed on heterogeneous computer servers, operating systems, hardware and software environments.

It is yet another objective of the present the present invention to provide systems and methods for managing the RPO of enterprise IT business continuity or disaster recovery solutions that interface with various data protection techniques used by the business continuity or disaster recovery solution.

It is still another objective of the present the present invention to provide systems and methods for managing the RPO of enterprise IT business continuity or disaster recovery solutions that may be implemented in software.

It is another objective of the present invention to provide systems and methods for managing the RPO of enterprise IT business continuity or disaster recovery solutions that may be implemented in distributed or centralized environments.

To meet the above mentioned and other objectives, the present invention provides a system for management of Recovery Point Objective (RPO) of a business continuity or disaster recovery solution. The system comprises a management server logically coupled with at least a first computer, at least a second computer, and a network coupling the first and the second computers. The first and second computers host at least one continuously available application and at least one data protection scheme for replicating the application data; the application data being periodically replicated from the first computer to at least the second computer. The system managing RPO by inputting an RPO value for the solution, calculating a real time RPO value for the solution, and making the real time RPO value equal to the input RPO value.

In an embodiment of the present invention, the first and the second computers are coupled to one or more storage units. A plurality of agents of the management server are deployed on at least the first computer, at least the second computer, the network coupling the first and the second computers, and the one or more storage units. The management server periodically polls at least one of its agents integrated with at least, the application and the data protection scheme running on the first computer, the application and the data protection scheme running on the second computer, and the network, for calculating the real time RPO value. In an embodiment of the present invention, the management server periodically polls at least one of its agents integrated with at least one storage unit, for calculating the real time RPO value. The data protection scheme comprises data replication techniques based on one or more of tape backup, disk backup, block level replication, file level replication, point in time replication and archive logs. The system of the present invention is configurable on heterogeneous platforms comprising heterogeneous servers and operating systems.

The present invention also provides a method for management of Recovery Point Objective (RPO) of a business continuity or disaster recovery solution. The method comprises the steps of inputting an RPO value for the solution, calculating a real time RPO value for the solution, and managing the real time RPO value to make it equal to the input RPO value. The method further comprises the step of continuously repeating the steps of calculating a real time RPO value for the solution and managing the real time RPO value to make it equal to the input RPO value.

In an embodiment of the present invention, the step of inputting an RPO value for the solution comprises the steps of prompting a user to input a desired RPO value for the solution, computing time and periodic setting values for the solution, based on the desired RPO value, and configuring the solution, based on the computed time and periodic setting values.

In an embodiment of the present invention, the step of calculating a real time RPO value for the solution comprises the steps of obtaining current state of an application of the solution, obtaining current state of a data protection scheme replicating the application data, obtaining current state of a network supporting the solution, and calculating a real time RPO value using at least one of the current obtained values of each of the state of the application, the data protection scheme and the network.

In an embodiment of the present invention, the step of managing the real time RPO value to make it equal to the input RPO value comprises the steps of raising an alarm if the computed RPO value is not equal to the input RPO value, and performing at least one corrective action based on at least one predefined corrective policy. In another embodiment of the present invention, the step of managing the real time RPO value to make it equal to the input RPO value comprises the steps of raising an alarm if the computed RPO value is not equal to the input RPO value, prompting the user to define at least one corrective policy, and performing at least one corrective action based on the user defined corrective policy.

In an embodiment of the present invention, the step of managing the real time RPO value to make it equal to the input RPO value comprises the step of repeating the steps of calculating a real time RPO value for the solution if the computed RPO value is equal to the input RPO value.

In an embodiment of the present invention, the step of computing time and periodic setting values for the solution based on the desired RPO value, comprises one or more of the steps of computing a value of periodic replication interval for application specific environment variables, computing values of periodic intervals for performing data consistency checks for application data that is replicated, computing values of periodic intervals for applying replicated application data on at least one secondary computer, computing values of periodic polling intervals for network link availability and usage, computing values of periodic polling intervals for checking server up-times, and computing values of periodic polling intervals for checking storage up-times.

The method for management of Recovery Point Objective (RPO) of a business continuity or disaster recovery solution described in the present invention is operable on heterogeneous platforms comprising heterogeneous servers and operating systems.

The present invention also provides a computer program product comprising a computer usable medium having a computer readable program code embodied therein for management of Recovery Point Objective (RPO) of a business continuity or disaster recovery solution. The computer program product comprises program instruction means for inputting an RPO value for the solution, program instruction means for calculating a real time RPO value for the solution, and program instruction means for managing the real time RPO value to make it equal to the input RPO value. In an embodiment of the present invention, the computer program product further comprises program instruction means for continuously repeating the steps of calculating a real time RPO value for the solution and managing the real time RPO value to make it equal to the input RPO value.

In an embodiment of the present invention, the program instruction means for inputting an RPO value for the solution comprise program instruction means for prompting a user to input a desired RPO value for the solution, program instruction means for computing time and periodic setting values for the solution, based on the desired RPO value, and program instruction means for configuring the solution, based on the computed time and periodic setting values.

In an embodiment of the present invention, the program instruction means for calculating a real time RPO value for the solution comprise program instruction means for obtaining current state of an application of the solution, program instruction means for obtaining current state of a data protection scheme replicating the application data, program instruction means for obtaining current state of a network supporting the solution, and program instruction means for calculating a real time RPO value using at least one of the current obtained values of each of the state of the application, the data protection scheme and the network.

In an embodiment of the present invention, the program instruction means for managing the real time RPO value to make it equal to the input RPO value comprise program instruction means for raising an alarm if the computed RPO value is not equal to the input RPO value, and program instruction means for performing at least one corrective action based on at least one predefined corrective policy. In another embodiment of the present invention, the program instruction means for managing the real time RPO value to make it equal to the input RPO value comprise program instruction means for raising an alarm if the computed RPO value is not equal to the input RPO value, program instruction means for prompting the user to define at least one corrective policy, and program instruction means for performing at least one corrective action based on the user defined corrective policy.

In an embodiment of the present invention, the program instruction means for managing the real time RPO value to make it equal to the input RPO value comprise program instruction means for repeating the steps of calculating a real time RPO value for the solution, if the computed RPO value is equal to the input RPO value.

In an embodiment of the present invention, the program instruction means for computing time and periodic setting values for the solution based on the desired RPO value, comprise one or more of program instruction means for computing a value of periodic replication interval for application specific environment variables, program instruction means for computing values of periodic intervals for performing data consistency checks for application data that is replicated, program instruction means for computing values of periodic intervals for applying replicated application data on at least one secondary computer, program instruction means for computing values of periodic polling intervals for network link availability and usage, program instruction means for computing values of periodic polling intervals for checking server up-times, and program instruction means for computing values of periodic polling intervals for checking storage up-times.

The computer program product for management of Recovery Point Objective (RPO) of a business continuity or disaster recovery solution described in the present invention is operable on heterogeneous platforms comprising heterogeneous servers and operating systems.

### BRIEF DESCRIPTION OF THE ACCOMPANYING DRAWINGS

The present invention is described by way of embodiments illustrated in the accompanying drawings wherein:

FIG. 1 illustrates an exemplary environment in which the system for management of recovery point objectives (RPO) for maintaining business continuity of an Information Technology (IT) solution operates;

FIG. 2A and FIG. 2B depict a flowchart illustrating the steps involved in monitoring, measurement and management of Recovery Point Objectives (RPO) of an enterprise IT business continuity or disaster recovery solution, in accordance with an embodiment of the present invention;

FIG. 3 is a screenshot of an exemplary GUI for prompting a user to input a desired RPO value, in accordance with an embodiment of the present invention; and

FIG. 4 is a screenshot of an exemplary GUI conveying the difference between the computed and user input RPO values, in accordance with an embodiment of the present invention.

### DETAILED DESCRIPTION OF THE INVENTION

The present invention would now be discussed in context of embodiments as illustrated in the accompanying drawings.

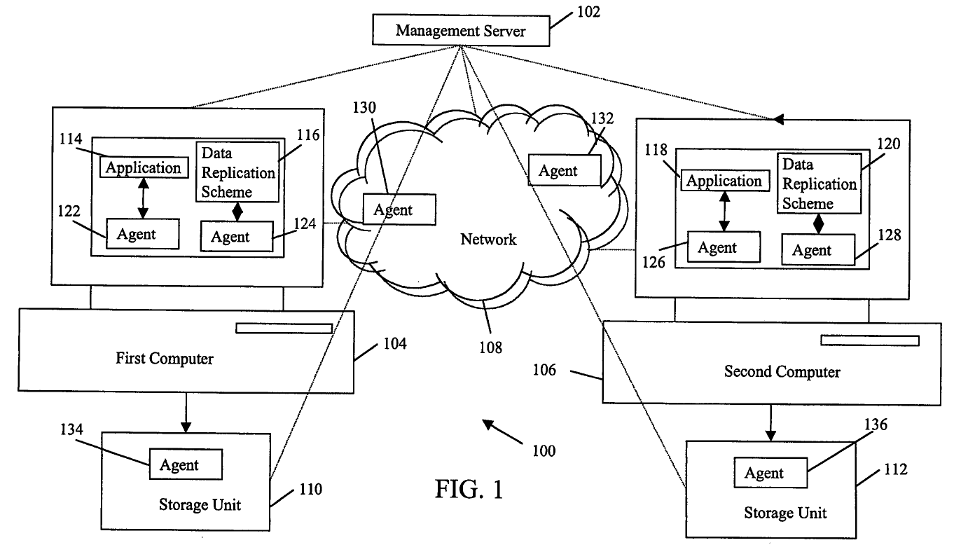

FIG. 1 illustrates an exemplary environment in which the system for management of recovery point objectives (RPO) for maintaining business continuity of an Information Technology (IT) enterprise operates, in accordance with an embodiment of the present invention. System 100 comprises a management server 102, a first computer 104, a second computer 106, a network 108 connecting the first computer 104 and the second computer 106, a first storage unit 110 connected to the first computer 104, and a second storage unit 112 connected to the second computer 106. An application 114 of the IT enterprise that is required to be available continuously runs on the first computer 104. A data protection scheme 116 is configured to protect the application 114. An instance 118 of the application 114 runs on the second computer 106. An instance 120 of the data protection scheme 116 is configured to protect the application 118. In an embodiment of the present invention, both the first and the second computers are connected to a single storage unit. In different embodiments of the present invention, there may be more than one first and/or second computers and/or storage units. The second computer 106 is maintained in a standby mode. In various embodiments of the present invention, the second computer 106 may be maintained in hot, cold or warm standby modes.

In accordance with an embodiment of the present invention, the first computer 104 and the second computer 106 are at geographically separate locations. The management server 102 is logically connected to the first computer 104, the second computer 106, the network 108, the first storage unit 110 and the second storage unit 112. In an embodiment of the present invention the logical connection maybe an IP network connection.

In various embodiments of the present invention, the first storage unit 110 and the second storage unit 112 are connected to the first computer 104 and the second computer 106 respectively either as direct attached SCSI connection or using IP or Fibre Channel connectivity or any other connection method. Also, in various embodiments of the present invention, the network 108 may be a Local area network (LAN) or a Wide area network (WAN).

A plurality of agents of the management server 102 are deployed on the first computer 104, the second computer 106, the network 108, the first storage unit 110 and the second storage unit 112. Agents 122 and 126 are integrated with the applications 114 and 118 respectively. The Agents 122 and 126 continuously monitor and maintain the state of the applications 114 and 118 and provide a real time status to the management server 102.

Agents 124 and 128 are integrated with the data protection schemes 116 and 120 respectively and continuously monitor and maintain the state of the data protection schemes. In an embodiment, the agents 124 and 128 monitor and maintain replication logs and queue sizes of the data protection scheme. In various embodiments of the present invention, varied data protection schemes may be used. In an embodiment, a traditional tape backup scheme is used wherein the application 114 data on the first computer 104 is replicated (backed up) onto tape media. This replicated application data is then transported from the tape media to the second computer 106. Then the application data on the tape media is restored onto the application 118 running on the second computer 106 resulting in the recovery of the application 114.

In another embodiment of the present invention, block level replication using storage array is used as the data protection scheme, wherein the storage volumes, on which archive logs are stored on the first computer 104 are replicated to the second computer 106. These volumes are then restored onto the second computer 106, and applied to the application 118, resulting in the recovery of the application 114. In other embodiments, various other data protection schemes such as file based replication techniques that replicate archive log files may be used. The system 100 for management of recovery point objectives (RPO) for maintaining business continuity of an Information Technology (IT) enterprise as described in the present invention, fully supports configuration of any type of data protection scheme being used. The system 100 also supports the monitoring and administration of the data protection scheme being used.

Agents 130 and 132 of the management server 102 are integrated with the network 108, agent 134 is coupled with the first storage unit 110 and agent 136 is coupled with the second storage unit 112, as illustrated in FIG. 1. The management server 102 periodically communicates with its agents using both synchronous and asynchronous communication techniques to monitor and maintain the state of the various components of the system 100.

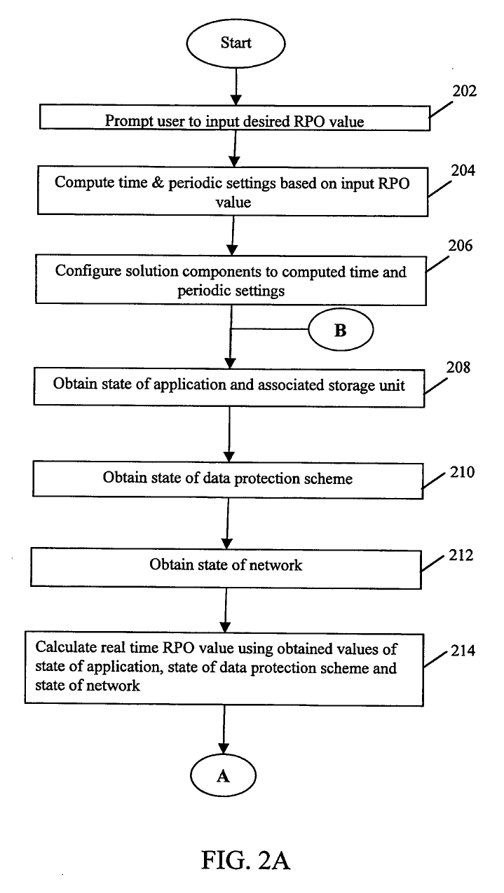

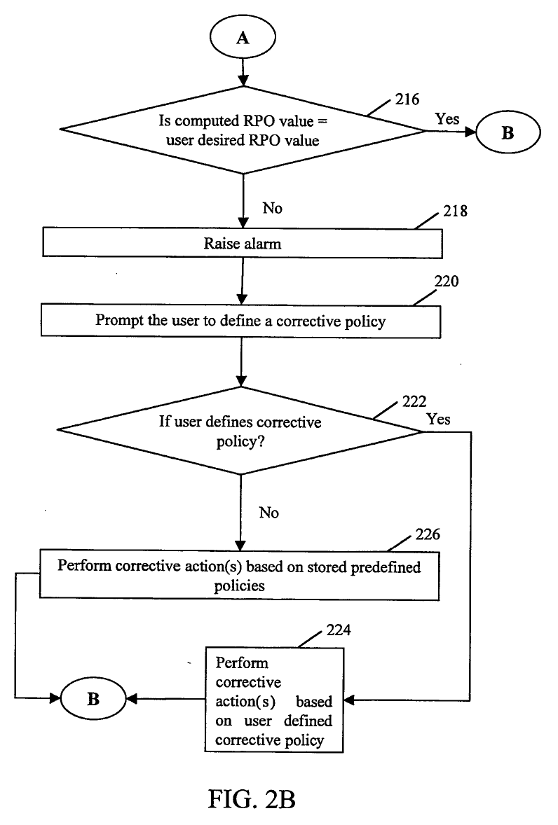

FIG. 2 is a flowchart illustrating the steps involved in monitoring, measurement and management of Recovery Point Objectives (RPO) of an enterprise IT business continuity or disaster recovery solution, in accordance with an embodiment of the present invention.

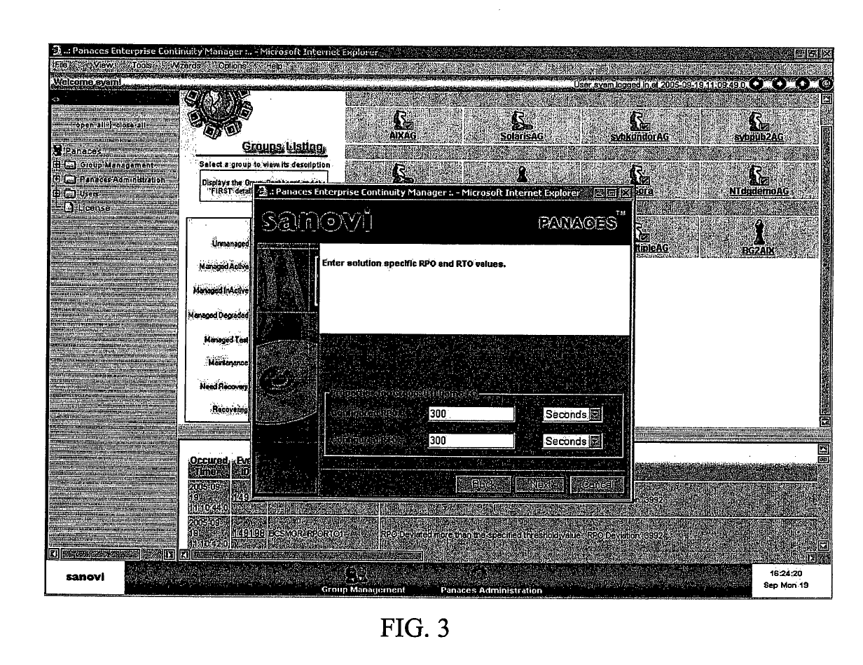

At step 202, a user is prompted to enter a desired RPO value. In an embodiment of the present invention, the user is prompted to enter a desired RPO value for either the entire solution or an application thereof, via a graphical user interface (GUI). FIG. 3 illustrates an exemplary GUI for prompting the user to input a desired RPO value. In an embodiment of the present invention, the user may also be prompted to input a desired recovery time objective (RTO) value. RTO for an enterprise IT business continuity or disaster recovery solution is a time measure that indicates how soon data and related applications must be available to the enterprise after an outage. In another embodiment, the user may only be prompted to input a desired RPO value.

In other embodiments of the present invention, the user may enter desired RPO value using a command line interface.

In an exemplary embodiment of the present invention, an Oracle database running on the first computer 104 must be available continuously. Consequently, an instance of Oracle database is also maintained, in a running condition, on the second computer 106, which computer is maintained in a standby mode. Oracle database is protected and recovered using the archive log technique, which is well known in the art. Archive logs are periodically dumped on the first computer 104. These logs are also periodically replicated to the second computer 106 via a WAN connection. The archive logs are then applied to the Oracle instance running on the second computer 106.

The desired value of RPO as input by the user is used to determine configuration and behavior of rest of the components that make up the solution. In the embodiment of the present invention, where the application that must be available continuously is an Oracle database, the RPO value influences the following:
dumping frequency of the Oracle log on the first computer 104 is calculated based on the user input RPO value. The value is computed such that the following inequality is true:
   RPO value>=time to dump log on the first computer 104+time to replicate archive log from the first computer 104 to the second computer 106+time to apply archive log to the Oracle instance running on the second computer 106
archive log replication frequency from the first computer 104 to the second computer 106 is calculated based on the input RPO value
network bandwidth and archive log generated on the first computer 104 are sized based on the input RPO value
archive log application periodicity to the Oracle instance running on the second computer 106 is calculated based on the input RPO value

At step 204, time and periodic settings are computed and configured for the solution based on the value of RPO input at step 202. An enterprise IT business continuity or disaster recovery solution typically comprises an application that is required to be available continuously along with its environnent, a data protection/replication scheme and the entire infrastructure supporting the solution comprising server, storage & networks. Examples of the time and periodic settings that are computed comprise:
periodic replication intervals for application specific environment variables
periodic actions which enable the application data to be created in a consistent form. Examples of such actions comprise dumping of logs for a database (where the application being protected is a database) or taking a snapshot of the application data on the first computer 104. In an embodiment of the present invention, value of the periodicity of the action of dumping of logs is computed using the formula:
   dump-log interval on the first computer 104=user input RPO−time required for replication of log−time required to apply log on at least one second computer 106
replication of application data at periodic intervals
periodic setting up of data consistency checks for the application data that is replicated to one or more secondary sites. In an embodiment, the second computer 106 is an example of a secondary site while the first computer 104 is an example of a primary site.
periodic applying of replicated application data on one or many secondary sites. Examples of this action comprises applying of replicated logs for a database (where the application being protected is a database) to the second computer 106. In an embodiment of the present invention, value of the apply log frequency (where a log is being replicated from a primary to a secondary site) is adjusted to satisfy the following inequality:
   user input RPO value<=time stamp of application of archive log file sequence ‘N’−time stamp of dumped archive log file sequence ‘N’
computation of polling interval for WAN network link availability and usage. In an embodiment of the present invention, this polling interval is the interval between two successive times when the management server 102 communicates with the agents 130 and 132 which are integrated with the network 108.
computation of polling interval to check server up time. In an embodiment of the present invention, this polling interval is the interval between two successive times when the management server 102 communicates with its agents integrated with the first computer 104 and the second computer 106.
computation of polling interval to check storage up time. In an embodiment of the present invention, this polling interval is the interval between two successive times when the management server 102 communicates with the agents 134 and 136 coupled with the first storage 110 and the second storage 112 respectively.

Once the time and periodic settings are computed based on the user input RPO value, the computed settings are configured for the components of the solution, at step 206. In an embodiment of the present invention, the computed settings are configured by the management server 102 by communicating with its agents deployed on the various components of the system 100, to configure the computed values for each of the components.

At step 208, a current state of an application of the solution, which is required to be available continuously, along with any storage associated with the application is obtained. In an embodiment of the present invention, a current state of the application 114 or/and the application 118 is obtained by the management server 102 by polling the agents 122 and 126 which are integrated with the applications 114 and 118 respectively. Also, a current state of the first storage unit 110 and the second storage unit 112 is obtained by the management server 102 by polling the agents 134 and 136, which are integrated with the first storage unit 110 and the second storage unit 112 respectively. Examples of the values polled comprise:
state of application, where obtained values may be ‘open’ or ‘closed’ or ‘active’ or ‘degraded’; and
application load

At step 210, a current state of a data protection scheme that is coupled with the application of the solution, which is required to be available continuously, is obtained. In an embodiment of the present invention, a current state of the data replication scheme 116 or/and the data replication scheme 120 is obtained by the management server 102 by polling the agents 124 and 128 which are integrated with the data protection schemes 116 and 120 respectively. Examples of the values polled comprise:
replication queue size
replication log status
replication rate
last data signature copied from the first computer 104
last data signature written to the second computer 106

At step 212, a current state of a network supporting the application of the solution, which is required to be available continuously, is obtained. In an embodiment of the present invention, a current state of the network 108 is obtained by the management server 102 by polling the agents 130 and 132 which are integrated with the network 108. Examples of the values polled comprise:
network link utilization
network link delay
network alternate route information

At step 214, a real time RPO value is calculated using the obtained values of the state of the application and associated storage, the state of the data protection scheme and the state of the network at steps 208, 210 and 212. In an embodiment of the present invention, the current value of RPO is computed by the management server 102 by using values obtained by periodically polling each of its agents. Examples of values used to calculate the current value of RPO comprise:
time stamp of current application 114 data that is ready to be replicated from the first computer 104
time stamp of the last application 114 data set that is already applied to the application 118 running on the second computer 106
current state of the application 118 running on the second computer 106
current state of the first and the second storage units 110 and 112

In an embodiment of the present invention, current RPO value is calculated using the formula:
current RPO value=time stamp of the last consistent value of application 114 data generated at the first computer 104−time stamp of the last consistent application 114 data that is applied to the application 118 and is therefore, available at the second computer 106
In other embodiments other formulae may be used to compute a current RPO value for the solution, based on the values polled by the management server 102.

In the exemplary embodiment of the present invention, where an Oracle database running on the first computer 104 must be available continuously current RPO value is determined by obtaining the following information:
exact date, time and transaction number of the archive logs dumped on the first computer 104
exact date and time of the logs replicated from the first computer 104 to the second computer 106
exact date, time and transaction number of the archive logs that are applied to the Oracle instance running on the second computer 106
   Then, current real time RPO value is calculated using the time difference between the last successful archive log that is applied on the second computer 106 and the last complete archive log dumped on the first computer 104.

At step 216, the computed RPO value is compared to the RPO value that was input by the user at step 202. If the computed value is equal to the user input RPO value, steps 208 to 216 are repeated. If the computed value is not equal to the user input RPO value an alarm is raised, at step 218.

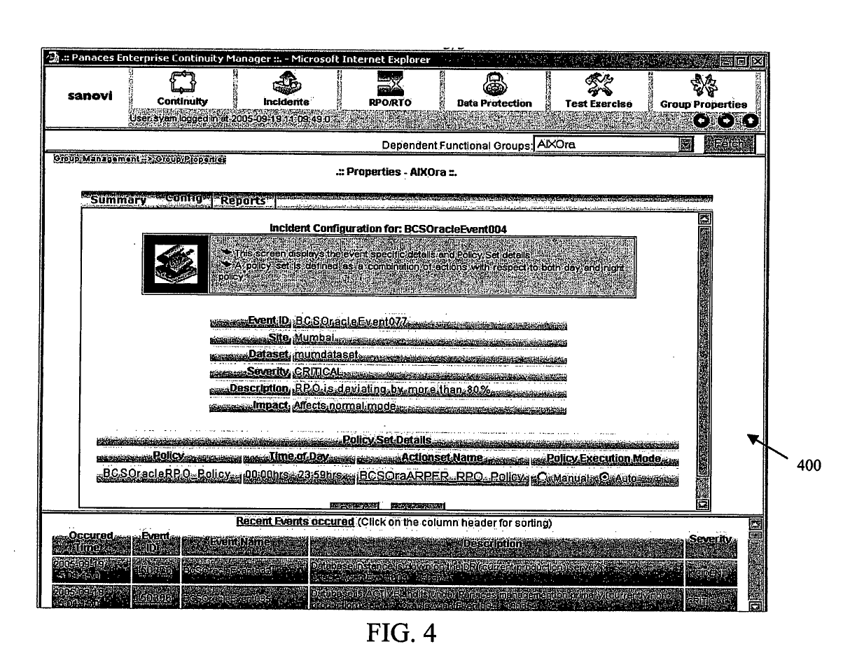

In an embodiment of the present invention, the difference between the computed RPO value and the user input RPO value is presented to the user via a GUI. FIG. 4 illustrates an exemplary screenshot of a GUI conveying the difference between the computed and user input RPO values, in accordance with an embodiment of the present invention. The GUI 400 presents the user with additional information such as the identity of the application, which is required to be available continuously, and the severity and impact of the difference between the computed and user input RPO values. In other embodiments of the present invention, some other additional information may also be presented to the user along with the difference between the computed and user input RPO values.

At step 220, the user is prompted to define a corrective policy, in order to restore the real time computed RPO value to the RPO value initially input by the user. In an embodiment of the present invention the user may be prompted to define a corrective policy via a GUI. This GUI may be the same or be different from the GUI which presents the difference between the computed and user input RPO values. The GUI may also present the user with a set of corrective policy options and prompt the user to either choose one of those or define a new corrective policy.

If the user chooses to define a corrective policy at step 222, then at step 224 a corrective action that restores the RPO value is taken based on the user defined corrective policy. Upon completion of step 224, steps 208 to 216 are repeated.

If the user chooses not to define a corrective policy at step 222, then at step 226 a corrective action that restores the RPO value is taken based on a predefined corrective policy. In an embodiment of the present invention, a set of predefined corrective policies are stored in the management server 102 and these policies are applied by the management server 102 onto the first computer 104 the second computer 106 or the network 108, based on the states of these components as obtained via the agents deployed on them. A predefined corrective policy is selected for execution based on the cause of deviation of the computed real time RPO value from the user input RPO value. RPO deviation can be due to various causes. Examples of such causes comprise:
unavailability of sufficient network bandwidth on the network 108
replication queue length of the data protection scheme 116, 120 exceeding an average value
very high CPU utilization on the first computer 104
insufficient storage space on the first computer 104 or the second computer
application being down on the first computer 104 or the second computer 106

Examples of corrective policies that can be executed in response to the above causes are:
route data via an alternate network route
change replication priority amongst applications, so that the important applications have a minimum data lag
change process priority on the first computer 104 to manage CPU utilization
free up storage based on a purging policy
failover to the second computer 106 if the application is not available on the first computer 104
custom response based on the user requirement
   In various embodiments of the present invention, each of the above corrective policies may be executed automatically on detection of a difference between the computed and user input RPO values, or require manual consent before execution. Upon completion of step 226, steps 208 to 216 are repeated.

In the exemplary embodiment of the present invention, where an Oracle database running on the first computer 104 must be available continuously, the following corrective actions may be taken when the computed real time RPO value deviates from the user input RPO value:
if archive log is not dumped at a predetermined interval an alarm is raised and a corresponding predefined action to the alarm action is taken
if replication rate has decreased, due to which file transfer times across the WAN has increased, a corrective action to increase bandwidth for replication may be taken or other replications that may be contesting for same bandwidth may be stopped
   if CPU usage on the first computer 104 or the second computer is higher then a threshold level, due to which archive log dumping or replication rate is affected, a corrective action to reduce load on the first computer 104 or the second computer 106 may be executed.

In various embodiments of the present invention, the system and method herein can operate in varied environments and on heterogeneous platforms such as heterogeneous servers and operating system environments. Examples of servers and central processing unit types that are supported by the present invention comprise Intel Pentium class, SUN Sparc, IBM PowerPC etc. Examples of the various operating systems that are supported are Microsoft Windows 2000, Microsoft Windows 2003, SUN Solaris 8, SUN Solaris 9, IBM AIX 5.3 etc.

While the present invention has been shown and described with reference to exemplary embodiments, it will be understood by those skilled in the art that various changes in form and detail may be made therein without departing from or offending the spirit and scope of the invention as defined by the appended claims.

What is claimed is:

1. A system for management of Recovery Point Objective (RPO) of a business continuity or disaster recovery solution, the system comprising:
a management server logically coupled with at least a first computer, at least a second computer, and a network coupling the first and the second computers;
at least one of the first and second computers hosting at least one continuously available application and at least one data protection scheme for replicating the application data; the application data being periodically replicated from the first computer to at least the second computer; the system managing RPO by inputting an RPO value for the solution, calculating a real time RPO value for the solution, and making the real time RPO value equal to the input RPO value.

2. The system of claim 1, wherein the first and the second computers are coupled to one or more storage units.

3. The system of claim 1, wherein a plurality of agents of the management server are deployed on at least the first computer, at least the second computer, the network coupling the first and the second computers, and the one or more storage units.

4. The system of claim 3, wherein the management server periodically polls at least one of its agents integrated with at least, the application and the data protection scheme running on the first computer, the application and the data protection scheme running on the second computer, and the network, for calculating the real time RPO value.

5. The system of claim 3, wherein the management server periodically polls at least one of its agents integrated with at least one storage unit, for calculating the real time RPO value.

6. The system of claim 1, wherein the data protection scheme comprises data replication techniques based on one or more of tape backup, disk backup, block level replication, file level replication, point in time replication and archive logs.

7. The system of claim 1 being configurable on heterogeneous platforms comprising heterogeneous servers and operating systems.

8. A method for management of Recovery Point Objective (RPO) of a business continuity or disaster recovery solution, the method comprising the steps of:
a. inputting an RPO value for the solution;
b. calculating a real time RPO value for the solution; and
c. managing the real time RPO value to make it equal to the input RPO value.

9. The method of claim 8, further comprising the step of continuously repeating the steps of calculating a real time RPO value for the solution and managing the real time RPO value to make it equal to the input RPO value.

10. The method of claim 8, wherein the step of inputting an RPO value for the solution comprises the steps of:
a. prompting a user to input a desired RPO value for the solution;
b. computing time and periodic setting values for the solution, based on the desired RPO value; and
c. configuring the solution, based on the computed time and periodic setting values.

11. The method of claim 8, wherein the step of calculating a real time RPO value for the solution comprises the steps of:
a. obtaining current state of an application of the solution;
b. obtaining current state of a data protection scheme replicating the application data;
c. obtaining current state of a network supporting the solution; and
d. calculating a real time RPO value using at least one of the current obtained values of each of the state of the application, the data protection scheme and the network.

12. The method of claim 11, wherein the data protection scheme comprises data replication techniques based on one or more of tape backup, disk backup, block level replication, file level replication, point in time replication and archive logs.

13. The method of claim 8, wherein the step of managing the real time RPO value to make it equal to the input RPO value comprises the steps of:
a. raising an alarm if the computed RPO value is not equal to the input RPO value; and
b. performing at least one corrective action based on at least one predefined corrective policy.

14. The method of claim 8, wherein the step of managing the real time RPO value to make it equal to the input RPO value comprises the steps of:
a. raising an alarm if the computed RPO value is not equal to the input RPO value;
b. prompting the user to define at least one corrective policy; and
c. performing at least one corrective action based on the user defined corrective policy.

15. The method of claim 8, wherein the step of managing the real time RPO value to make it equal to the input RPO value comprises the step of repeating the steps of calculating a real time RPO value for the solution, if the computed RPO value is equal to the input RPO value.

16. The method of claim 10 wherein, the step of computing time and periodic setting values for the solution based on the desired RPO value, comprises one or more of the steps of:
a. computing a value of periodic replication interval for application specific environment variables;
b. computing values of periodic intervals for performing data consistency checks for application data that is replicated;
c. computing values of periodic intervals for applying replicated application data on at least one secondary computer;
d. computing values of periodic polling intervals for network link availability and usage;
e. computing values of periodic polling intervals for checking server up-times; and
f. computing values of periodic polling intervals for checking storage up-times.

17. The method of claim 8 being operable on heterogeneous platforms comprising heterogeneous servers and operating systems.

18. A method for management of Recovery Point Objective (RPO) of a business continuity or disaster recovery solution, the method comprising the steps of:
a. prompting a user to input a desired RPO value for the solution;
b. computing time and periodic setting values for the solution based on the input RPO value;
c. configuring the solution based on the computed time and periodic setting values;
d. obtaining current state of an application of the solution;
e. obtaining current state of a data protection scheme replicating the application data;
f. obtaining current state of a network supporting the solution;
g. calculating a real time RPO value using at least one of the current obtained values of each of the state of the application, the data protection scheme and the network;
h. repeating steps d to g if the computed RPO value is equal to the input RPO value;
i. raising an alarm if the computed RPO value is not equal to the input RPO value;
j. prompting the user to define at least one corrective policy;
k. performing corrective actions based on the user defined corrective policy if the user defines at least one corrective policy; else
l. performing corrective actions based on at least one predefined corrective policy; and
m. repeating steps d to g.

19. A computer program product comprising a computer usable medium having a computer readable program code embodied therein for management of Recovery Point Objective (RPO) of a business continuity or disaster recovery solution, the computer program product comprising:
a. program instruction means for inputting an RPO value for the solution;
b. program instruction means for calculating a real time RPO value for the solution; and
c. program instruction means for managing the real time RPO value to make it equal to the input RPO value.

20. The computer program product of claim 19, further comprising program instruction means for continuously repeating the steps of calculating a real time RPO value for the solution and managing the real time RPO value to make it equal to the input RPO value.

21. The computer program product of claim 19, wherein program instruction means for inputting an RPO value for the solution comprise:
a. program instruction means for prompting a user to input a desired RPO value for the solution;
b. program instruction means for computing time and periodic setting values for the solution, based on the desired RPO value; and
c. program instruction means for configuring the solution, based on the computed time and periodic setting values.

22. The computer program product of claim 19, wherein program instruction means for calculating a real time RPO value for the solution comprise:
a. program instruction means for obtaining current state of an application of the solution;
b. program instruction means for obtaining current state of a data protection scheme replicating the application data;
c. program instruction means for obtaining current state of a network supporting the solution; and
d. program instruction means for calculating a real time RPO value using at least one of the current obtained values of each of the state of the application, the data protection scheme and the network.

23. The computer program product of claim 22, wherein the data protection scheme comprises data replication techniques based on one or more of tape backup, disk backup, block level replication, file level replication, point in time replication and archive logs.

24. The computer program product of claim 19, wherein program instruction means for managing the real time RPO value to make it equal to the input RPO value comprise:
a. program instruction means for raising an alarm if the computed RPO value is not equal to the input RPO value; and
b. program instruction means for performing at least one corrective action based on at least one predefined corrective policy;

25. The computer program product of claim 19, wherein the program instruction means for managing the real time RPO value to make it equal to the input RPO value comprise:
a. program instruction means for raising an alarm if the computed RPO value is not equal to the input RPO value;
b. program instruction means for prompting the user to define at least one corrective policy; and
c. program instruction means for performing at least one corrective action based on the user defined corrective policy;

26. The computer program product of claim 19, wherein the program instruction means for managing the real time RPO value to make it equal to the input RPO value comprise program instruction means for repeating the steps of calculating a real time RPO value for the solution, if the computed RPO value is equal to the input RPO value.

27. The computer program product of claim 21 wherein, the program instruction means for computing time and periodic setting values for the solution based on the desired RPO value, comprise one or more of:
a. program instruction means for computing a value of periodic replication interval for application specific environment variables;
b. program instruction means for computing values of periodic intervals for performing data consistency checks for application data that is replicated;
c. program instruction means for computing values of periodic intervals for applying replicated application data on at least one secondary computer;
d. program instruction means for computing values of periodic polling intervals for network link availability and usage;
e. program instruction means for computing values of periodic polling intervals for checking server up-times; and
f. program instruction means for computing values of periodic polling intervals for checking storage up-times.

28. The computer program product of claim 19 being operable on heterogeneous platforms comprising heterogeneous servers and operating systems.
